(19) United States
(12) Patent Application Publication
(10) Pub. No.: US 2026/0261746 A1
(43) Pub. Date: Sep. 3, 2026

(54) SYSTEM AND METHOD FOR AUTOMATED GENERATION OF A DIRECTED VIDEO STREAM

(71) Applicant: Vizi Inc.

(72) Inventors: Adam James Silver, Baiona (ES); William Bradshaw Pillow, Zionsville, IN (US)

(73) Assignee: Vizi Inc., (US)

(21) Appl. No.: 19/553,436

(22) Filed: Mar. 2, 2026

Related U.S. Application Data
(60) Provisional application No. 63/766,240, filed on Mar. 3, 2025.

(51) Int. Cl. H04N 21/854

(52) U.S. Cl. CPC H04N 21/854

(57) ABSTRACT

A system and method for the automated generation of a directed video stream from a plurality of distributed camera devices. Video streams captured by devices across multiple locations or users are transmitted via a communication network to a computing platform. The platform analyzes the streams to determine editorial selection decisions including stream selection, transition timing, and presentation ordering based on stream characteristics, predefined rules, or a trained machine learning model. A directed output video stream is generated by applying these decisions to the received streams. The computing platform may be implemented via mobile, edge, or cloud-based systems.

### REFERENCE TO RELATED APPLICATIONS

This application claims the benefit of U.S. Provisional Patent Application No. 63/766,240 titled “AI VIDEO CLOUD SERVICE AND MULTI-CAMERA SYSTEM”, filed on 03/03/2025, which is incorporated by reference herein in its entirety.

### TECHNICAL FIELD

The present disclosure relates generally to systems and methods for automated generation of directed video streams from distributed camera devices. More particularly, the disclosure relates to a computing platform configured to receive a plurality of video streams from camera devices distributed across multiple locations, analyze the video streams to determine editorial selection decisions comprising stream selection, transition timing, and presentation order, and generate a directed output video stream by applying the editorial selection decisions to the plurality of video streams.

### BACKGROUND

The proliferation of mobile devices and connected cameras has made it possible to capture a single real-world occurrence from a multitude of different perspectives. In environments such as live events, sports, or social gatherings, dozens or even hundreds of independent camera devices may be recording the same event simultaneously. However, transforming these disparate, unsynchronized video streams into a cohesive and engaging "directed" video production remains a significant technical challenge.

Traditional video production relies on a manual workflow where a human director monitors multiple feeds and makes real-time decisions about which camera angle to broadcast. While effective for high-budget professional productions, this model does not scale to the massive volume of user-generated content or distributed camera networks. To address this, automated switching systems have been developed; however, many existing solutions are either integrated into the capture hardware itself limiting their ability to coordinate with other cameras or rely on simplistic triggers that fail to maintain narrative continuity.

Furthermore, many automated systems struggle with the technical variability inherent in distributed camera networks. Video streams arriving from different users or locations often vary in resolution, frame rate, bitrate, and network stability. Existing systems frequently fail to account for these stream characteristics when making editorial decisions, leading to output videos that may switch to a low-quality or lagging feed at a critical moment.

There is also a lack of intelligent coordination in how distributed feeds are prioritized.

In professional broadcast environments, such as sports production, live performances, or event coverage, human-directed workflows are feasible due to the availability of trained personnel and specialized infrastructure. However, these workflows do not scale well to emerging use cases involving large numbers of cameras, distributed capture devices, or consumer-level deployments.

### SUMMARY

To address the aforementioned challenges, the present disclosure provides a system and method for automated generation of a directed video stream from a plurality of distributed camera devices, wherein a computing platform analyzes received video streams and stream characteristics derived therefrom to determine editorial selection decisions.

In one aspect, a system is disclosed comprising a communication device and a computing platform. The communication device is configured to receive a plurality of video streams from camera devices distributed across multiple locations. The computing platform is configured to analyze the plurality of video streams to determine one or more editorial selection decisions comprising stream selection, transition timing, and presentation order, and to generate a directed output video stream by applying the editorial selection decisions to the plurality of video streams.

In another aspect, the computing platform evaluates specific stream characteristics such as frame rate, resolution, bitrate, continuity, and motion level to inform its editorial decisions. For example, the system may prioritize a stream with higher resolution or better continuity, or trigger a transition when it detects a significant change in motion within the current feed.

In some embodiments, the computing platform evaluates specific stream characteristics derived from the received video streams, including frame rate, resolution, bitrate, continuity, and motion level, to inform editorial selection decisions. In other embodiments, the system employs a trained machine learning model to output selection indicators based on the visual data. The computing platform is flexible in its deployment, capable of operating on mobile devices, edge/base stations, or cloud-based systems.

By centralizing the editorial intelligence and analyzing the inherent characteristics of the video streams, the system provides a scalable solution for creating professional-grade video content from a decentralized network of capture devices, ensuring that the most relevant and high-quality perspectives are presented to the viewer in a coherent sequence.

### BRIEF DESCRIPTION OF THE DRAWINGS

The detailed description of the present invention is described with reference to the accompanying figures. Same numbers are used throughout the drawings to reference like features and components.

FIG. 1 illustrates a block diagram of a system for automated generation of a directed video stream from a plurality of distributed camera devices, in accordance with an embodiment of the present disclosure.

FIG. 2 illustrates a block diagram of a computing platform showing hardware modules for receiving video streams, evaluating stream characteristics, applying editorial selection decisions, and generating a directed output video stream, in accordance with an embodiment of the present disclosure.

FIG. 3 illustrates a block diagram of a computing platform module for determining editorial selection decisions based on analysis of evaluated stream characteristics, in accordance with an embodiment of the present disclosure.

FIG. 4 illustrates a method for generating a directed video stream from distributed camera devices, in accordance with an embodiment of the present disclosure.

### DETAILED DESCRIPTION

The following detailed description is provided to illustrate representative embodiments of the present disclosure and is not intended to limit the scope of the invention, which is defined by the appended claims. The embodiments described herein may be implemented in a variety of forms, and the disclosure is not limited to the specific embodiments, structures, or configurations described. The following detailed description is provided to illustrate representative embodiments of the present disclosure relating to distributed camera capture and centralized or hybrid editorial selection. The description is not intended to limit the scope of the invention, which is defined by the appended claims. The embodiments described herein may be implemented in various forms, and the disclosure is not limited to the specific systems, methods, or configurations described. The embodiments described in this application relate to automated generation of a directed output video stream based on analysis of video streams captured by distributed camera devices and characteristics derived therefrom, and are not dependent on audio signals or telemetry data.

As used herein, the singular forms “a,” “an,” and “the” include plural referents unless the context clearly indicates otherwise. The terms “comprising,” “including,” and “having” are used in an open-ended sense and do not exclude additional elements or steps not expressly recited.

As used herein, the term “video stream” refers to a sequence of visual data captured over time by a camera device, whether continuous or segmented and regardless of encoding format. The term “camera device” refers to any device capable of capturing visual data and generating a corresponding video stream, including mobile devices, fixed cameras, wearable cameras, or vehicle-mounted cameras.

The term “editorial selection decision” refers to a decision that governs how video streams are selected, ordered, or transitioned in a directed output video stream, including, without limitation, selection of a video stream for presentation, determination of when to transition between video streams, or determination of a presentation order of video streams.

The term “computing platform” refers to one or more computing devices comprising one or more processors and one or more non-transitory computer-readable memories storing instructions that, when executed, cause the computing platform to perform the operations described herein. A computing platform may be implemented on a mobile device, an edge or base station, a cloud-based system, or a distributed combination thereof.

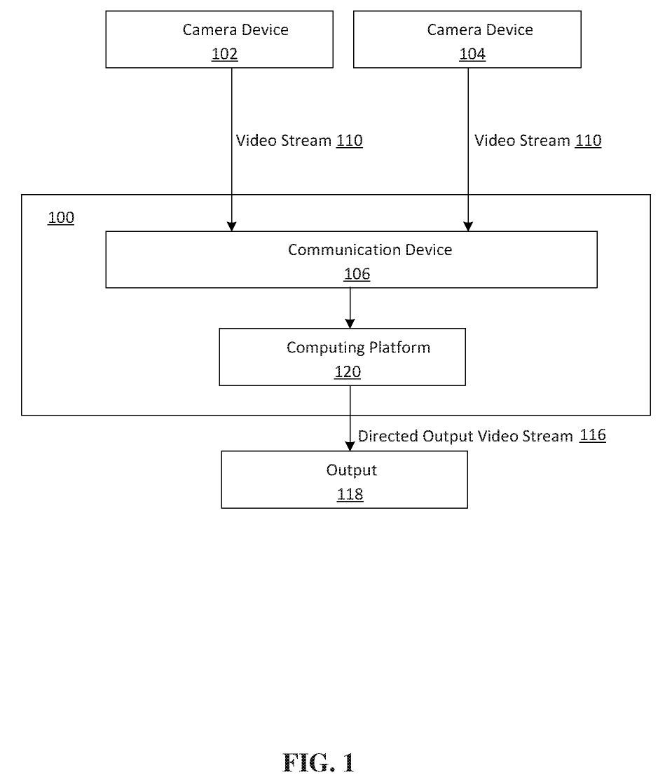

Unless expressly stated otherwise, the steps of the methods described herein are not required to be performed in the order shown, and steps may be combined, omitted, or reordered consistent with the appended claims. Referring to FIG. 1, a system 100 for automated generation of a directed video stream from distributed camera sources is illustrated. The system 100 is configured to receive video streams captured by a plurality of camera devices distributed across multiple users, devices, or locations, and to generate a directed output video stream based on editorial selection decisions determined by a computing platform.

In contrast to systems in which camera devices independently determine presentation or switching behavior, the system 100 centralizes editorial authority within the computing platform, while allowing capture to occur in a distributed and decentralized manner. The system 100 comprises a communication device 106 and a computing platform 120. Camera devices 102, which are external to the system 100, are distributed across multiple locations and transmit video streams 110 to the communication device 106 via a communication network. The system 100 does not include the camera devices as claimed elements; rather, the system receives the video streams generated by those external devices.

In some embodiments, the camera devices may be user-operated mobile devices, such as smartphones or wearable cameras. In other embodiments, the camera devices may include fixed-position cameras, vehicle-mounted cameras, or other capture devices deployed at different locations relative to the real-world occurrence. The camera devices operate independently with respect to capture. Each camera device captures visual data from its own viewpoint and generates a video stream without coordinating editorial decisions with other camera devices. The real-world occurrence captured by the plurality of camera devices may include any physical activity or event that unfolds over time and is observable from multiple viewpoints. Examples include live events, public gatherings, sporting events, performances, training exercises, or collaborative activities. Because the camera devices are distributed, the resulting video streams may differ in viewpoint, framing, timing, quality, and content. The system does not require the camera devices to be synchronized or configured in advance.

The system 100 includes a communication network configured to transmit the video streams generated by the plurality of camera devices to the computing platform 120. The communication network may include wired or wireless communication links and may comprise one or more networks. The communication network supports transmission of video streams from distributed camera devices that may be geographically dispersed or operated by different users. The system does not require a specific network topology or protocol. The computing platform 120 receives the video streams transmitted from the plurality of camera devices via the communication network. The computing platform comprises one or more processors and a non-transitory computer-readable memory storing instructions that, when executed, cause the computing platform to perform editorial selection operations.

A defining aspect of the system is that the computing platform determines editorial selection decisions based on analysis of the received video streams. The camera devices do not determine which video streams are presented, when transitions occur, or how streams are ordered in the directed output video stream. The computing platform may be implemented on a mobile device, an edge or base station, a cloud-based computing system, or a distributed combination thereof, depending on deployment requirements. Based on the editorial selection decisions determined by the computing platform, the system generates a directed output video stream 116. The directed output video stream represents a selected and ordered presentation of video content derived from the plurality of received video streams. The directed output video stream may be generated during capture of the real-world occurrence or after capture, and may be provided to an output, storage, or display system 118 (i.e., an output) for viewing, distribution, or storage. A key technical feature of the system 100 is the separation between capture and editorial decision-making. Camera devices are responsible solely for capturing visual data and generating video streams. Editorial decisions are determined exclusively by the computing platform. This separation allows the system to scale to large numbers of camera devices, supports heterogeneous capture environments, and enables automated generation of a coherent directed output video stream without requiring coordination or manual intervention at the camera devices.

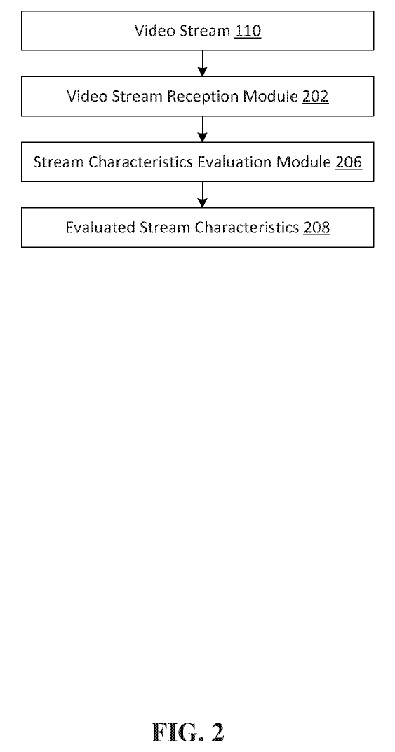

Referring to FIG. 2, the computing platform 120 includes a video stream reception module 202 configured to receive video streams 110 transmitted from the plurality of camera devices 102, 104 via the communication network. Each received video stream 110 corresponds to visual data captured by a respective camera device.

The computing platform 120 further includes a stream characteristic evaluation module 206 configured to evaluate one or more characteristics of each received video stream 110. The evaluated characteristics may include frame rate, resolution, bitrate, motion level, continuity, and stream availability, each derived from the corresponding video stream 110.

In some embodiments, the video stream reception module 202 temporarily buffers received video streams 110 to accommodate variations in arrival time or network conditions prior to evaluation by the stream characteristic evaluation module 206. The stream characteristic evaluation module 206 generates evaluated stream characteristics 208 representing observable properties of the received video streams 110. The evaluated stream characteristics 208 are maintained as intermediate data for use in subsequent editorial selection processing.

In some embodiments, the reception module may temporarily buffer received video data to accommodate variations in arrival time or network conditions. Such buffering is performed for stream management and characteristic evaluation and does not involve editorial selection. The computing platform further includes a stream characteristic evaluation module 206 configured to evaluate one or more characteristics of the received video streams 110. The evaluated characteristics may include, without limitation, frame rate, resolution, bitrate, motion level, continuity, and stream availability. Evaluation of stream characteristics is performed independently for each video stream. The system does not require that all characteristics be evaluated for each stream, and different subsets of characteristics may be evaluated in different embodiments. Frame rate evaluation may include determining a rate at which frames are received for a video stream over a period of time. The computing platform may determine instantaneous frame rate values, average frame rate values, or frame rate variability metrics.

Frame rate evaluation provides information indicative of temporal properties of the video stream and is used as an input to subsequent editorial selection decisions. Resolution evaluation may include determining spatial dimensions of frames associated with a video stream. Bitrate evaluation may include determining a data rate at which video data is received for the stream.

Resolution and bitrate characteristics may vary among distributed camera devices due to device capabilities or network conditions. The computing platform evaluates such characteristics without requiring modification of capture parameters at the camera devices.

Motion level evaluation may include determining a degree of visual change within a video stream over time. The computing platform may evaluate motion level based on frame-to-frame differences or other indicators of visual activity. Motion level is evaluated independently for each video stream and is represented as part of the evaluated stream characteristics associated with that stream. Continuity evaluation may include determining whether a video stream is received consistently over time, whether frames are missing or delayed, or whether the stream experiences interruptions.

Continuity information may be used to characterize reliability of a video stream and is evaluated without excluding the stream from subsequent processing. Stream availability evaluation may include determining whether a video stream is currently active, temporarily unavailable, or newly available. Distributed camera devices may join or leave dynamically during operation of the system.

Availability status is evaluated and stored as part of the stream characteristics associated with each video stream. The evaluation of stream characteristics described is performed independently of editorial selection decision determination.

During the stream characteristic evaluation phase, the computing platform generates evaluated stream characteristics as intermediate data representing observable properties of the received video streams. The evaluated stream characteristics are maintained for use in subsequent editorial selection processing and may include, without limitation, temporal, spatial, or quality-related indicators derived from the video streams. The computing platform is configured to evaluate stream characteristics for video streams that may be asynchronous with respect to one another, and temporal alignment among video streams is not required during generation of the evaluated stream characteristics.

In some embodiments, evaluated characteristics may be associated with timestamps or sequence indicators to facilitate later comparison. Evaluated stream characteristics may be stored in memory as structured data associated with respective video streams. The representation may include numerical values, flags, counters, or other indicators corresponding to evaluated characteristics. The disclosure does not require a particular data structure for storing evaluated characteristics. Upon completion of characteristic evaluation, the computing platform maintains evaluated stream characteristics for the plurality of video streams.

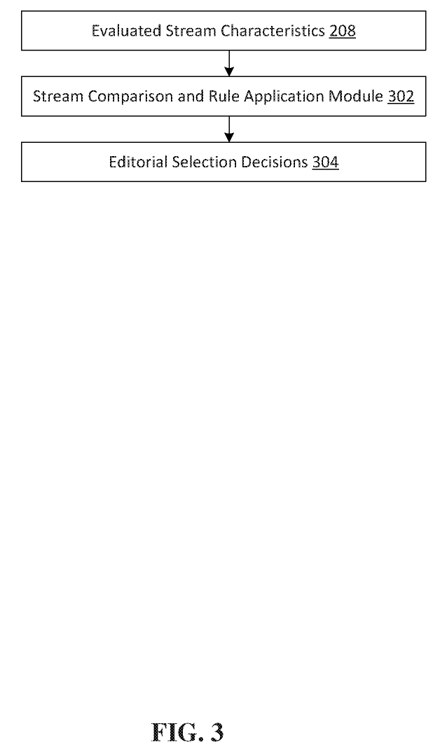

Referring to FIG. 3, the computing platform 120 includes an editorial selection module 302 (i.e., stream comparison and rule application module) configured to receive the evaluated stream characteristics 208 generated by the stream characteristic evaluation module 206. The editorial selection module 302 compares evaluated stream characteristics 208 across the plurality of video streams 110 and determines one or more editorial selection decisions 304.

The editorial selection decisions 304 may include selection of a video stream for presentation, determination of a transition time between video streams, and determination of a presentation order of video streams. The editorial selection decisions 304 are generated based on application of predefined selection rules and/or a trained machine learning model operating on the evaluated stream characteristics 208.

The comparison operation may include identifying differences, similarities, or relative relationships among evaluated characteristics of the video streams. Comparison does not require normalization of characteristics across streams and may be performed using direct or derived values. The predefined selection rules map one or more evaluated stream characteristics to editorial outcomes, as described below. In some embodiments, determining the editorial selection decisions comprises selecting at least one video stream from the plurality of video streams for presentation based on comparison of evaluated stream characteristics.

For example, the computing platform may compare evaluated motion levels, continuity indicators, or availability status across streams to determine which stream is selected for presentation at a given time. Selection may involve identifying a stream that satisfies one or more predefined criteria, or that is preferred relative to other streams. Selection does not require exclusion of non-selected streams from further processing, and non-selected streams may continue to be evaluated and compared as additional data is received. In some embodiments, determining the editorial selection decisions comprises determining a time at which to transition between video streams. Transition timing may be determined based on detected changes in evaluated stream characteristics over time.

For example, the computing platform may detect a change in continuity, motion level, or availability of a currently presented stream and determine that a transition to a different stream is appropriate. Transition timing determination does not require that transitions occur at fixed intervals and may be dynamically determined during operation. In some embodiments, determining the editorial selection decisions comprises determining a presentation order of the plurality of video streams. Presentation order determination may include assigning priority values to video streams based on evaluated characteristics and ordering the streams accordingly.

Priority values may be static or dynamic and may be updated as evaluated characteristics change. The presentation order may govern an initial ordering of streams, a fallback ordering, or an ordering used when multiple streams satisfy selection criteria. Predefined selection rules applied by the stream comparison and rule application module may define relationships between evaluated stream characteristics and editorial outcomes. Such rules may specify conditions under which a particular stream is selected, conditions under which transitions occur, or conditions under which ordering is updated.

The disclosure does not require a specific rule format or rule language. Rules may be implemented using conditional logic, lookup tables, or other programmatic constructs. Editorial selection decisions may be updated dynamically as additional video streams are received or as evaluated stream characteristics change. The computing platform may re-compare evaluated characteristics and re-apply selection rules without interrupting generation of the directed output video stream. Dynamic updating enables the system to adapt to changes in stream availability, quality, or activity during operation. In some embodiments, determining the editorial selection decisions may comprise applying a trained machine learning model to the received video streams or to evaluated stream characteristics derived therefrom.

The trained machine learning model may output one or more selection indicators corresponding to editorial outcomes, including selection of a video stream, transition timing, or presentation order. Use of a trained machine learning model is optional and does not replace the comparison and rule-based mechanisms described above. In embodiments that support both rule-based and machine learning-based decision determination, the computing platform may selectively apply one or both mechanisms. For example, rule-based processing may be used as a primary mechanism, with machine learning-based processing used as a supplemental mechanism. The disclosure does not require a particular interaction between rule-based and model-based processing, and implementations may vary.

Referring to FIGS. 1 and 3, the output generation processing receives as inputs: the plurality of video streams received from the distributed camera devices; and the editorial selection decisions determined by the computing platform.

The editorial selection decisions may include one or more of: selection of a video stream for presentation, determination of a transition time between video streams, and determination of a presentation order of video streams.

The output generation processing applies the editorial selection decisions as determined and does not modify the decisions during generation of the directed output video stream. The computing platform is configured to generate a directed output video stream by selecting video data from the plurality of received video streams in accordance with the editorial selection decisions.

In some embodiments, generating the directed output video stream comprises outputting frames or segments from a selected video stream while that video stream is designated for presentation. When a transition is specified, the computing platform ceases output from a currently selected video stream and begins output from a newly selected video stream at the determined transition time.

The disclosure does not require that video streams be modified at the camera devices. Selection and switching are performed by the computing platform. When the editorial selection decisions specify a transition between video streams, the computing platform executes the transition by switching output from a first video stream to output from a second video stream.

Transitions may be executed at frame boundaries, segment boundaries, or other suitable boundaries. The disclosure does not require a particular transition technique, and transitions may be abrupt or gradual depending on implementation. When the editorial selection decisions include a presentation order, the computing platform enforces the presentation order during generation of the directed output video stream. The presentation order may define a sequence in which video streams are presented, a fallback ordering, or a prioritization applied during operation. Presentation order may be applied continuously or intermittently and may be updated dynamically as editorial selection decisions are updated.

The computing platform may dynamically apply updated editorial selection decisions during generation of the directed output video stream. For example, when editorial selection decisions are updated based on newly received video streams or changes in evaluated stream characteristics, the computing platform may adjust video stream selection, transition timing, or presentation order accordingly. The dynamic application of updated decisions enables continuous generation of the directed output video stream during operation of the system. Generation of the directed output video stream is performed independently of the camera devices. The camera devices do not receive instructions regarding which video stream is selected for presentation, when transitions occur, or how video streams are ordered. This separation supports scalability and allows camera devices to operate without awareness of editorial selection decisions. The directed output video stream may be provided to one or more output destinations, including display devices, storage systems, or distribution systems. The disclosure does not require a particular output format or destination.

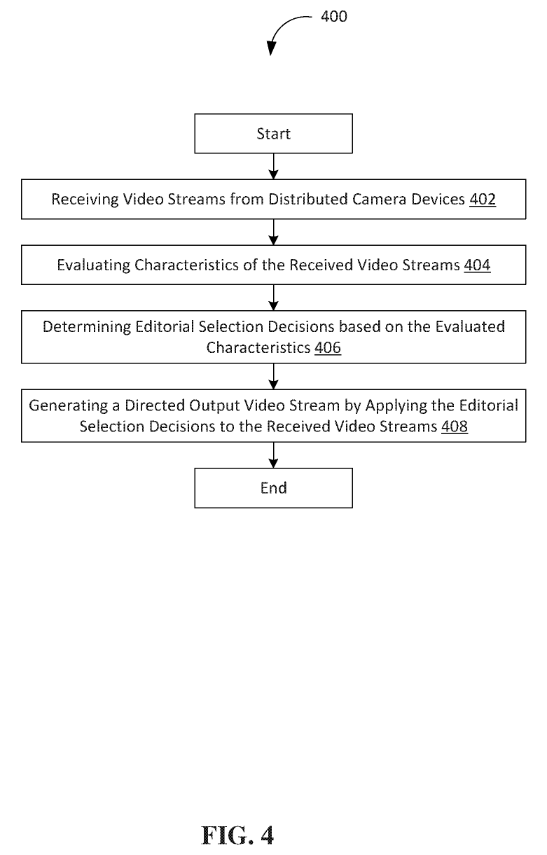

The directed output video stream may be generated in real time during capture of the real-world occurrence or after capture of the video streams. The operations described herein correspond to method steps involving generating a directed output video stream by applying editorial selection decisions to the plurality of received video streams, as illustrated in FIG. 4.

Referring to FIG. 4, a method 400 for generating a directed video stream is illustrated. The method 400 includes receiving video streams from distributed camera devices (step 402), evaluating characteristics of the received video streams (step 404), determining editorial selection decisions based on the evaluated characteristics (step 406), and generating a directed output video stream by applying the editorial selection decisions to the received video streams (step 408).

In one representative implementation, a plurality of users attend a live event such as a concert, sporting event, festival, or public gathering. Each user operates a mobile device comprising a camera device configured to capture visual data associated with the event. Each mobile device independently generates a video stream corresponding to the captured visual data and transmits the video stream to the computing platform via a communication network. The users do not coordinate capture behavior, framing, or timing, and do not control editorial selection decisions.

The computing platform receives the plurality of video streams and evaluates stream characteristics for each stream, including frame rate, resolution, motion level, continuity, and stream availability. Based on comparison of evaluated stream characteristics and application of predefined selection rules, the computing platform determines editorial selection decisions and generates a directed output video stream. In some instances, certain users may capture video intermittently, experience network interruptions, or operate devices with lower capture quality.

The computing platform evaluates continuity and availability characteristics and may dynamically adjust selection and transition timing to favor streams exhibiting greater stability, without requiring exclusion of other streams from evaluation. As additional users begin capturing video during the event, new video streams are received and evaluated. The computing platform updates editorial selection decisions dynamically to incorporate newly available streams into the comparison process. In another representative implementation, a plurality of fixed-position camera devices are deployed at different locations within a venue, such as along a track, stage, or facility. Each camera device captures visual data from a distinct viewpoint and generates a corresponding video stream.

The video streams are transmitted to a computing platform operating on a cloud-based system. The computing platform evaluates stream characteristics and determines editorial selection decisions without requiring synchronization or coordination among the camera devices.

The directed output video stream generated by the computing platform may present a sequence of video segments derived from different fixed-position cameras, with transitions determined based on evaluated characteristics such as motion level or continuity. In some implementations, camera devices may be distributed across geographically distinct locations associated with a broader activity or coordinated event. For example, camera devices may capture video at different locations along a route, course, or distributed environment.

Each camera device captures visual data independently and transmits a video stream to the computing platform. The computing platform evaluates stream characteristics and determines editorial selection decisions that govern which streams are presented and in what order.

This implementation demonstrates that the disclosed system does not require spatial proximity among camera devices and can operate across geographically distributed capture environments. In many real-world scenarios, camera devices may dynamically join or leave during operation of the system. For example, users may begin or stop capturing video at arbitrary times, or camera devices may become unavailable due to power or network conditions.

The computing platform evaluates availability and continuity characteristics to detect when video streams become newly available or unavailable. Editorial selection decisions are updated dynamically to reflect the current set of available video streams. The directed output video stream may be updated to include video segments derived from newly available streams or to transition away from streams that become unavailable, without interrupting output generation.

In one implementation, the computing platform determines editorial selection decisions using predefined selection rules applied to evaluated stream characteristics. Selection rules may specify relationships between stream characteristics and editorial outcomes. For example, video streams exhibiting higher continuity may be preferred for presentation; transitions may be triggered when motion level decreases below a threshold; or presentation order may prioritize streams received from certain camera devices. The predefined selection rules are applied by the computing platform and do not require modification of camera device behavior. In another implementation, the computing platform determines editorial selection decisions using a trained machine learning model. The trained machine learning model may process evaluated stream characteristics or received video streams to output selection indicators corresponding to editorial outcomes.

The machine learning model may be trained using historical video stream data, simulated capture scenarios, or annotated training examples. The disclosure does not require a particular training technique or model architecture.

Machine learning-based selection may be used independently or in combination with rule-based selection mechanisms. For example, rule-based selection may be used as a fallback mechanism when machine learning outputs are unavailable. In some implementations, the computing platform operates in a hybrid configuration comprising edge computing resources and cloud computing resources. For example, video stream reception and characteristic evaluation may be performed at an edge device or base station, while editorial selection decisions are determined at a cloud-based system.

In other implementations, editorial selection decisions may be determined at the edge, with generation of the directed output video stream performed at a cloud-based system.

The disclosure does not require a specific distribution of processing tasks, provided that editorial selection decisions are determined by the computing platform rather than by the camera devices. In real-time operation, the computing platform dynamically evaluates stream characteristics, determines editorial selection decisions, and generates the directed output video stream while video streams are being captured.

Transitions between video streams may occur dynamically based on updated editorial selection decisions, allowing the directed output video stream to adapt to changes in stream characteristics or availability during capture. In post-capture operation, the computing platform receives previously captured video streams and evaluates stream characteristics after capture has completed. Editorial selection decisions are determined based on the evaluated characteristics, and a directed output video stream is generated after capture. Post-capture operation may be used to generate summaries, highlights, or edited outputs from distributed capture environments.

In some implementations, the system may operate with a large number of distributed camera devices, including tens, hundreds, or thousands of camera devices. The computing platform evaluates stream characteristics independently for each stream and determines editorial selection decisions without requiring coordination among camera devices.

This implementation demonstrates scalability of the disclosed system to large distributed capture environments. In all implementations described herein, camera devices do not determine which video streams are selected for presentation, when transitions occur, or how streams are ordered. Camera devices remain unaware of editorial selection decisions and operate independently.

This separation supports scalability, simplifies camera device implementation, and centralizes editorial control within the computing platform. The representative implementations described herein illustrate various ways in which the disclosed system may be implemented. The disclosure does not limit the system to the specific scenarios described, and additional variations and combinations are possible without departing from the scope of the appended claims. The embodiments described herein are intended to illustrate representative implementations of the disclosed system and method and are not intended to limit the scope of the appended claims. Numerous variations, modifications, and alternative implementations are possible without departing from the scope of the claims.

The plurality of camera devices may include devices with heterogeneous capabilities. For example, some camera devices may support high-resolution capture, while others may support lower resolution capture. Some camera devices may capture video continuously, while others may capture video intermittently. The computing platform does not require uniformity among camera devices and evaluates stream characteristics independently for each video stream. Variations in device capability do not prevent operation of the disclosed system. The communication network may experience varying latency, bandwidth availability, or packet loss. The computing platform is configured to receive video streams under varying network conditions and to evaluate stream characteristics accordingly.

For example, transient network interruptions may result in reduced continuity or availability for certain video streams. The computing platform may detect such conditions through stream characteristic evaluation and update editorial selection decisions dynamically, without requiring reconfiguration of camera devices or interruption of output generation. In some embodiments, one or more video streams may become temporarily unavailable during operation of the system. The computing platform may continue to generate the directed output video stream based on available video streams and update editorial selection decisions as stream availability changes. Temporary unavailability of a video stream does not require termination of output generation and does not require modification of the claims. The editorial selection decisions may be determined based on different combinations of evaluated stream characteristics in different implementations. Some implementations may prioritize continuity, while others may prioritize motion level, resolution, or availability.

The disclosure does not require a particular weighting or prioritization of characteristics, and different selection criteria may be applied depending on configuration, deployment environment, or operational goals. Predefined selection rules may be expressed in various forms, including conditional logic, decision trees, priority tables, or other programmatic constructs. The disclosure does not require a particular rule structure or representation. Rules may be static or dynamically configurable and may be updated without modifying the camera devices or underlying capture behavior. As described previously, some embodiments may use trained machine learning models to determine editorial selection decisions. The use of machine learning is optional and may be omitted entirely in some implementations.

Where machine learning models are used, the models may be updated, retrained, or replaced over time without altering the fundamental architecture of the system or method described herein. The computing platform may be implemented using a single computing device or multiple cooperating computing devices. For example, stream reception and characteristic evaluation may be performed at an edge device, while editorial selection decisions are determined at a cloud-based system.

Alternatively, all processing may be performed on a single device, such as a mobile device or local server. The disclosure does not require a specific allocation of processing tasks among computing resources. Editorial selection decisions may be updated continuously, periodically, or in response to detected changes in evaluated stream characteristics. The frequency and timing of updates may vary across implementations.

The disclosure does not require real-time operation, and editorial selection decisions may be determined in near-real-time or after capture has completed. The directed output video stream may be generated in various formats suitable for different output destinations. For example, the directed output video stream may be formatted for live streaming, on-demand playback, archival storage, or distribution to multiple recipients.

The disclosure does not limit the directed output video stream to a particular encoding format or distribution mechanism. The disclosed system is scalable to large numbers of camera devices. The computing platform may evaluate stream characteristics and determine editorial selection decisions for each video stream independently, enabling operation with tens, hundreds, or thousands of camera devices. Scalability does not require coordination among camera devices and is achieved through centralized or hybrid processing. In some embodiments, failure of individual components, such as loss of connectivity to a camera device or failure of a computing resource, may result in reduced availability of certain video streams. The system may continue to operate using available video streams and computing resources, demonstrating graceful degradation rather than complete failure. The disclosed system does not require user interaction to determine editorial selection decisions. Users operating camera devices are not required to select video streams, trigger transitions, or define presentation order. This independence supports automated operation and reduces burden on users participating in distributed capture. The architectural examples described in FIGS. 1–4 illustrate representative implementations of the disclosed system and method. The disclosure does not require that all components illustrated in the figures be present in a particular implementation. Components may be combined, omitted, or rearranged without departing from the scope of the appended claims.

The disclosed system may be integrated with existing capture, streaming, or distribution systems. Camera devices may operate using standard capture and transmission mechanisms, and the computing platform may interface with existing infrastructure. The embodiments, implementations, and examples described herein are provided for illustrative purposes and are not intended to limit the scope of the invention. The disclosure contemplates that features described in connection with one embodiment may be combined with features described in connection with other embodiments, unless such combination is expressly excluded or technically infeasible.

In some embodiments, the invention may inherently improve multi-camera live production technology by solving a technical problem of generating a coherent program stream from concurrent camera stream without human editing latency, where conventional systems either require a human director or perform only rudimentary switching that fails under variable stream quality and event dynamics; in some embodiments, the improvement may be implemented by continuously deriving, for each camera stream, one or more stream characteristic comprising frame rate, resolution, bitrate, continuity, motion level, and stream availability, and then applying an editorial selection decision that may include selecting a camera stream, determining a transition time, and determining a presentation order; in some embodiments, the stream characteristic may be computed at a frame window granularity by measuring inter-frame motion vector magnitude as a proxy for motion level, measuring timestamp discontinuity or missing-frame rate as a proxy for continuity, and measuring encoder output rate or transport throughput as a proxy for bitrate and availability; in some embodiments, the editorial selection decision may be applied as a deterministic state machine that may maintain a currently selected camera stream and may trigger switching when the stream characteristic crosses a threshold for a dwell time, such as switching away from a camera stream when continuity degrades or when motion level drops below an action threshold, thereby improving shot relevance and program stability without manual intervention.

In some embodiments, the invention may inherently improve video stream quality management technology by solving a technical problem of selecting a camera stream that remains visually usable despite heterogeneous camera placement and changing conditions, where a typical approach would accept the user-selected feed or would treat all feeds as equivalent; in some embodiments, the computing platform may perform comparative scoring across camera stream using predefined selection criteria that may map individual stream characteristic to a composite quality score, such as weighting continuity and resolution higher for “establishing” shots and weighting motion level higher for “action” shots; in some embodiments, the scoring may be implemented using rule evaluation that may set hysteresis bands to prevent oscillation, such as requiring a candidate camera stream to exceed a current camera stream score by a margin for a minimum time before a transition; in some embodiments, the scoring may be implemented using a trained machine learning model that may output a selection indicator for each camera stream, where the selection indicator may encode a probability of being the “best” shot and may be combined with availability constraints to select a camera stream that is both compelling and decodable.

In some embodiments, the invention may inherently improve low-latency stream switching and synchronization technology by solving a technical problem of switching between camera stream without producing glitch, stall, or temporal inconsistency at the directed output video stream, particularly when camera stream may arrive with different transport delay and different encoding cadence; in some embodiments, the computing platform may implement transition timing that may be determined based on a detected change in stream characteristic over time, such as a change in motion level or continuity, and may schedule a switch at a boundary that may minimize discontinuity; in some embodiments, the boundary may be selected at a keyframe boundary, a segment boundary, or a frame timestamp alignment point that may be derived from the camera stream metadata, thereby reducing decode artifacts and improving viewer experience in the directed output video stream; in some embodiments, the computing platform may continuously monitor per-stream arrival jitter and may delay the directed output video stream by a bounded buffer to align candidate camera stream on a common timeline before applying the editorial selection decision, thereby improving temporal consistency of switching.

In some embodiments, the invention may inherently improve edge-cloud deployment technology for video direction by solving a technical problem of where to perform editorial selection decisions to balance latency, compute load, and network backhaul consumption, where conventional architectures either push everything to cloud (incurring latency and bandwidth) or confine everything to device (incurring compute limits); in some embodiments, the computing platform may be implemented as at least one of a mobile device, an edge or base station, a cloud-based computing system, or a distributed combination thereof, and the same editorial selection logic may be executed in whichever location may satisfy a selected objective function; in some embodiments, an edge or base station may perform first-pass analysis of stream characteristic and may emit only selection indicator and reduced descriptors to a cloud service, thereby reducing uplink bandwidth while retaining cloud-level orchestration; in some embodiments, a cloud-based system may perform model-based selection indicator inference using aggregated camera stream when compute scale is desirable, while a local device may perform fallback rule-based selection when connectivity degrades, thereby improving resilience of the directed output video stream generation.

In some embodiments, the invention may inherently improve editorial automation technology by solving a technical problem of translating raw stream characteristic into production-like editing decisions that include shot selection, cut point selection, and ordering, where conventional “auto-switch” systems may only select a feed but may not manage ordering and cut timing coherently; in some embodiments, the computing platform may assign a priority value to each camera stream and may order camera stream based on the priority value, where the priority value may be dynamically updated during receipt of camera stream to reflect evolving conditions such as motion spikes or continuity degradation; in some embodiments, dynamic updating may be implemented by maintaining a per-stream priority accumulator that may integrate recent stream characteristic and may decay older samples, thereby allowing the directed output video stream to react quickly to new action while avoiding abrupt instability.

In some embodiments, the invention may inherently improve stream orchestration technology for multi-source capture by solving a technical problem of centralizing editorial selection decisions while keeping camera device simple, where conventional multi-camera rigs may require cameras to coordinate or embed complex logic; in some embodiments, the camera device may be configured to transmit camera stream without performing editorial selection, and the computing platform may perform all editorial selection decisions, thereby improving scalability to more camera device and enabling consistent editorial behavior across heterogeneous camera device.

In some embodiments, the invention may inherently improve event-centric capture technology by solving a technical problem of emphasizing salient real-world occurrence segments across distributed camera device, where conventional systems may require a human to find highlights; in some embodiments, the computing platform may determine a transition time based on detected change in motion level and continuity within a currently presented camera stream, thereby switching to a camera stream that may better depict the occurrence when action increases or when the current feed becomes unstable; in some embodiments, the computing platform may also determine the presentation order based on priority value to produce a program-like narrative flow rather than a static single-view feed.

In some embodiments, the invention may inherently improve machine learning inference application in live direction by solving a technical problem of producing actionable selection indicator in real time from multiple concurrent camera stream, where conventional offline editing models may not meet latency or continuity constraints; in some embodiments, the trained machine learning model may be configured to consume representations derived from stream characteristic rather than raw pixel data to reduce compute cost, such as embedding motion level statistics, continuity flags, and availability scores; in some embodiments, the trained machine learning model may be configured to output a per-stream selection indicator at a regular cadence and the computing platform may then apply a smoothing filter or majority vote over successive outputs before switching, thereby improving stability of the editorial selection decision while retaining adaptivity.

In some embodiments, additional technical improvements may be added to improve network transport technology for multi-camera SaaS ingestion by solving a technical problem of backhaul congestion and variable uplink when many camera device transmit concurrently; in some embodiments, the computing platform may implement an adaptive uplink shaping mechanism that may request camera device to adjust an encoding setting or segment cadence based on observed ingress congestion at the SaaS server, where the request may be expressed as a control message that may prioritize maintaining continuity and availability signals needed for editorial selection; in some embodiments, the adaptive shaping may include selectively requesting lower bitrate for non-selected camera stream while maintaining higher bitrate for a selected camera stream, thereby improving end-to-end bandwidth efficiency while preserving directed output video stream quality; in some embodiments, the mechanism may include opportunistic burst upload of higher-quality segments when network headroom is detected, thereby improving archival quality without harming live direction.

In some embodiments, additional technical improvements may be added to improve privacy-preserving video analytics technology by solving a technical problem of performing editorial selection decisions while reducing exposure of raw video content to the SaaS layer; in some embodiments, the computing platform may derive stream characteristic and selection indicator at an edge or base station and may transmit only those descriptors to the SaaS service for decisioning, where the SaaS service may generate the directed output video stream by requesting only the selected time-aligned segments from camera device; in some embodiments, the descriptors may include motion level, continuity, and availability signals sufficient for editorial selection while omitting or obfuscating identifying visual content, thereby improving privacy posture while maintaining functionality; in some embodiments, the edge or base station may apply on-device feature extraction for the trained machine learning model to avoid transmitting raw frames for inference, thereby improving privacy and reducing uplink load.

In some embodiments, additional technical improvements may be added to improve robustness of editorial decision technology by solving a technical problem of rapid oscillation (“thrash”) between camera stream when stream characteristic are noisy; in some embodiments, the computing platform may include a decision stabilization mechanism that may implement hysteresis, minimum-hold timers, and confidence intervals around selection indicator; in some embodiments, the stabilization mechanism may be implemented by requiring the candidate camera stream to exceed the current camera stream score for a defined duration, and may additionally require continuity to remain above a threshold, thereby improving directed output video stream smoothness; in some embodiments, the stabilization mechanism may be implemented by a hidden-state model that may treat “scene” as a latent variable inferred from stream characteristic time series, thereby improving temporal coherence of camera selection without adding manual rules.

In some embodiments, additional technical improvements may be added to improve time alignment technology across distributed camera device by solving a technical problem of drift and misalignment between camera stream clocks that can degrade transition timing and continuity scoring; in some embodiments, the computing platform may compute cross-stream alignment offsets using content-based alignment signals derived from stream characteristic time series, such as correlating motion energy envelopes across camera stream to infer relative delay; in some embodiments, the computing platform may apply the offsets to normalize timestamps prior to generating the directed output video stream, thereby improving switch timing accuracy and reducing perceived discontinuity; in some embodiments, the alignment may be periodically refreshed to compensate for clock drift during longer capture sessions.

In some embodiments, additional technical improvements may be added to improve model lifecycle technology for SaaS-based editorial selection by solving a technical problem of deploying a trained machine learning model that remains accurate across different event types and camera placements; in some embodiments, the SaaS platform may maintain multiple trained model variant and may select a model variant based on observed distributions of stream characteristic, such as typical motion level range or continuity pattern, thereby improving selection indicator accuracy without requiring per-user retraining; in some embodiments, the SaaS platform may perform online calibration by learning per-camera bias terms from historical stream characteristic and previously selected outcomes, thereby improving personalization of editorial selection decision while keeping the camera device unchanged.

In some embodiments, additional technical improvements may be added to improve directed output video stream generation technology by solving a technical problem of constructing an output stream that remains decodable and consistent despite heterogeneous source encoding; in some embodiments, the computing platform may normalize encoding parameters for selected segments, such as enforcing a common codec profile and a common segment duration, before concatenation into the directed output video stream; in some embodiments, the computing platform may implement a segment re-packaging pipeline that may rewrite container timestamps and may insert transition metadata, thereby improving player compatibility and reducing playback errors for the directed output video stream delivered via the SaaS service.

In some embodiments, each of the above inherent and additional improvements may be implemented in a manner that remains dependent on the primary capability of analyzing stream characteristic across multiple camera stream and generating a directed output video stream based on an editorial selection decision, and each improvement may be realized using permissive combinations of rule-based selection, trained machine learning inference, dynamic priority update, and distributed execution across a mobile device, an edge or base station, a cloud-based computing system, or a distributed combination thereof.

The absence of a particular feature in a described embodiment does not imply that the feature is required or excluded in other embodiments. As used in the appended claims, the terms “comprising,” “including,” “having,” and similar terms are intended to be open-ended and do not exclude additional elements, steps, or operations not expressly recited in the claims.

Use of the term “based on” does not require that a determination or operation be based exclusively on the recited factors, unless expressly stated otherwise. Nothing in the detailed description is intended to be construed as a disclaimer of claim scope, whether express or implied. Descriptions of specific embodiments, features, or advantages are not intended to limit the invention to those embodiments, features, or advantages.

Statements describing objectives, benefits, or advantages of certain embodiments should not be interpreted as limiting the claims to embodiments that achieve all or any such objectives, benefits, or advantages. Certain claims recite functional language describing operations performed by components of the system or steps of the method. Such functional language is intended to cover all implementations that perform the recited functions, regardless of the particular mechanism, algorithm, or structure used to perform such functions, unless expressly limited by the claims.

The disclosure does not require a specific implementation technique unless explicitly recited. Unless explicitly stated otherwise, the order of method steps recited in the claims is not intended to require performance in the recited order. Steps may be performed in different orders, in parallel, or in combination, provided that the claimed method as a whole is performed.

References to a “computing platform,” “computing device,” “processor,” or similar component are intended to encompass implementations using a single device or multiple cooperating devices. Operations described as being performed by a single component may be distributed across multiple components, and operations described as being performed by multiple components may be combined into a single component. The operations described herein may be implemented using software, hardware, firmware, or any combination thereof. Software implementations may be embodied as instructions stored on a non-transitory computer-readable medium and executed by one or more processors.

The disclosure does not require a particular programming language, operating system, or hardware platform. Any reference to a computer-readable medium refers to a non-transitory computer-readable medium, unless expressly stated otherwise. Such media may include, without limitation, memory devices, storage devices, or other tangible media capable of storing instructions.

What is claimed is:

1. A system for automated generation of a directed video stream, the system comprising:
a communication device configured to receive a plurality of video streams from a plurality of camera devices distributed across multiple locations; and
a computing platform communicatively coupled with the communication device, the computing platform comprising one or more processors and a non-transitory computer-readable memory storing instructions that, when executed by the one or more processors, cause the computing platform to:
a) analyze the plurality of video streams to determine one or more editorial selection decisions, the one or more editorial selection decisions comprising at least one of:° selecting a video stream from the plurality of video streams for presentation,° determining a time at which to transition between video streams of the plurality of video streams, ° determining a presentation order of the plurality of video streams; andb) generate a directed output video stream by applying the one or more editorial selection decisions to the plurality of video streams;
wherein the computing platform comprises at least one of a mobile device, an edge or base station, a cloud-based computing system, or a distributed combination thereof.

2. A method for generating a directed video stream from distributed camera devices, the method comprising:
receiving, by a computing platform, a plurality of video streams transmitted from a plurality of camera devices distributed across multiple locations;
analyzing, by the computing platform, the plurality of video streams to determine one or more editorial selection decisions, the one or more editorial selection decisions comprising at least one of:
selecting a video stream from the plurality of video streams for presentation,
determining a time at which to transition between video streams of the plurality of video streams, and
determining a presentation order of the plurality of video streams; and
generating, by the computing platform, a directed output video stream by applying the one or more editorial selection decisions to the received video streams.

3. The system of claim 1, wherein the analyzing of the plurality of video streams comprises evaluating one or more stream characteristics selected from frame rate, resolution, bitrate, continuity, motion level, and stream availability.

4. The system of claim 3, wherein the determining of the one or more editorial selection decisions comprises comparing the one or more stream characteristics of the plurality of video streams to select the video stream for the presentation.

5. The system of claim 1, wherein the selecting of the video stream for presentation comprises selecting the video stream that satisfies one or more predefined selection criteria.

6. The system of claim 5, wherein the one or more predefined selection criteria comprise prioritizing video streams received from a subset of the plurality of camera devices.

7. The system of claim 1, wherein the determining of the time at which to transition between the video streams comprises determining a transition time based on a detected change in one or more stream characteristics of at least one of the plurality of video streams over time.

8. The system of claim 7, wherein the detected change comprises at least one of a change in motion level and a continuity within a currently presented video stream.

9. The system of claim 1, wherein the determining of the presentation order of the plurality of video streams comprises assigning priority values to the plurality of video streams and ordering the plurality of video streams based on the priority values.

10. The system of claim 9, wherein the priority values are dynamically updated during receipt of the plurality of video streams.

11. The system of claim 1, wherein the determining of the one or more editorial selection decisions comprises applying predefined selection rules that map one or more characteristics of the plurality of video streams to at least one of video stream selection, transition timing, and presentation order.

12. The system of claim 1, wherein the determining of the one or more editorial selection decisions comprises applying a trained machine learning model to the plurality of video streams.

13. The system of claim 12, wherein the trained machine learning model outputs one or more selection indicators corresponding to the one or more editorial selection decisions.

14. The system of claim 1, wherein the plurality of camera devices do not perform editorial selection of the directed output video stream.

15. The method of claim 2, wherein the analyzing of the plurality of video streams comprises evaluating one or more characteristics of the plurality of video streams.

16. The method of claim 15, wherein the one or more characteristics comprise at least one of frame rate, resolution, motion level, and stream continuity.

17. The method of claim 2, wherein the determining of the one or more editorial selection decisions comprises applying a predefined selection rule to the plurality of video streams.

18. The method of claim 2, wherein the determining of the one or more editorial selection decisions comprises applying a trained machine learning model to the plurality of video streams.

19. The method of claim 2, further comprising dynamically updating the one or more editorial selection decisions as additional video streams are received.
